(19) United States
(12) Patent Application Publication
(10) Pub. No.: US 2023/0333813 A1
(43) Pub. Date: Oct. 19, 2023

(54) SECURE COMPUTATION SYSTEM, SECURE COMPUTATION SERVER APPARATUS, SECURE COMPUTATION METHOD, AND SECURE COMPUTATION PROGRAM

(71) Applicant: NEC Corporation, Minato-ku, Tokyo (JP)

(72) Inventor: Hikaru TSUCHIDA, Tokyo (JP)

(73) Assignee: NEC Corporation, Minato-ku, Tokyo (JP)

(21) Appl. No.: 18/023,317

(22) PCT Filed: Aug. 26, 2020
(86) PCT No.: PCT/JP2020/032229

§ 371 Date: Feb. 24, 2023

(51) Int. Cl. G06F 7/499; G06F 7/72

(52) U.S. Cl. CPC G06F 7/49931; G06F 7/723

(57) ABSTRACT

A secure computation system for secure exponentiation involving a non-secret base and a secret exponent comprises at least four secure computation server apparatuses connected to each other via a network, and each of the secure computation server apparatuses has: a reshare part that outputs reshares for an input including at least a share of the exponent by an operation closed within each of the secure computation server apparatuses; and a multiplication part that performs the secure exponentiation by executing multiplication using shares obtained by having the reshare part reshare the exponent that has been decomposed into additions of shares of the exponent.

### TECHNICAL FIELD

The present invention relates to a secure computation system, secure computation server apparatus, secure computation method, and secure computation program.

### BACKGROUND

In recent years, the research and development of a technology called secure computation have been active. Secure computation is a technique that executes a predetermined process while keeping the computation process and the results secret from a third party. Multi-party computation is one of the representative techniques of secure computation. In multi-party computation, confidential data is distributed to a plurality of servers (secure computation server apparatuses), and arbitrary computations are executed on the data, which is kept secret. Further, the data distributed to each secure computation server apparatus is called a “share.” Hereinafter, the term “secure computation” as used herein refers to multi-party computation, unless otherwise specified.

Exponentiation can be one of the secure computation processes, and exponential operations in secure computation are broadly classified into two types. In one type, both the exponent and base values are kept secret, and in the other, the exponent value is secret but not the base value. Further, as a combination, there may be a case where the base value is secret but not the exponent value, however, since the base value can be trivially derived by secure multiplication, there is no problem as a secure exponentiation.

Even secure exponentiation where the base value is not secret has a practical advantage. In some cases, secure computation is performed after the base value is made public, such as when the base value is a prime number or is a power of two. For instance, Patent Literature 1 describes an example of secure exponentiation where the exponent is secret.

### CITATION LIST

### Patent Literature

[Patent Literature 1] International Publication Number WO2020/152831

### Non-Patent Literature

[Non-Patent Literature 1] Megha Byali, et al., “FLASH: Fast and Robust Framework for Privacy-preserving Machine Learning,” Proceedings on Privacy Enhancing Technologies 2020
[Non-Patent Literature 2] Harsh Chaudhari, et al., “Trident: Efficient 4PC Framework for Privacy Preserving Machine Learning,” The Network and Distributed System Security Symposium (NDSS) 2020

### SUMMARY

### Technical Problem

The disclosure of each literature in Citation List above is incorporated herein in its entirety by reference thereto. The following analysis is given by the present inventors.

There are different levels of security in secure computation, and two representative security levels are semi-honest secure and malicious secure. Attacks that try to obtain as much information as possible about the values of inputs and computation processes while following the protocol are called semi-honest attacks, and being semi-honest secure means that security against these semi-honest attacks is ensured. Meanwhile, attacks that not only try to obtain information by deviating from the protocol, but also try to falsify the computation results are called malicious attacks, and being malicious secure means that security against these malicious attacks is ensured.

The secure exponentiation described in Patent Literature 1 is basically semi-honest secure and may be able to detect a malicious attack probabilistically, but it is not capable of definitive fraud detection. The reason for this is that, in the secure exponentiation described in Patent Literature 1, secret data is distributed to three secure computation server apparatuses. If one of the three secure computation server apparatuses tampers with a computation result, the two remaining secure computation server apparatuses cannot verify the falsification of the computation result while maintaining confidentiality. Ensuring definitive security against malicious attacks requires secure computation using at least four secure computation server apparatuses (for instance, refer to Non-Patent Literatures 1 and 2).

In view of the problem above, it is an object of the present invention to provide a secure computation system, secure computation server apparatus, secure computation method, and secure computation program that contribute to definitive fraud detection in secure exponentiation.

### Solution to Problem

According to a first aspect of the present invention, there is provided a secure computation system for secure exponentiation involving a non-secret base and a secret exponent, comprising at least four secure computation server apparatuses connected to each other via a network, wherein each of the secure computation server apparatuses has: a reshare part that outputs reshares for an input including at least a share of the exponent by an operation closed within each of the secure computation server apparatuses; and a multiplication part that performs the secure exponentiation by executing multiplication using shares obtained by having the reshare part reshare the exponent that has been decomposed into additions of shares of the exponent.

According to a second aspect of the present invention, there is provided a secure computation server apparatus out of at least four secure computation server apparatuses connected to each other via a network, the secure computation server apparatus including: a reshare part that outputs reshares for an input including at least a share of the exponent by an operation closed within each of the secure computation server apparatuses; and a multiplication part that performs the secure exponentiation by executing multiplication using shares obtained by having the reshare part reshare the exponent that has been decomposed into additions of shares of the exponent.

According to a third aspect of the present invention, there is provided a secure computation method performing secure exponentiation involving a non-secret base and a secret exponent using at least four secure computation server apparatuses connected to each other via a network, the secure computation method including: a resharing step of outputting reshares for an input including at least a share of the exponent by an operation closed within each of the secure computation server apparatuses; and a multiplication step of performing the secure exponentiation by executing multiplication using shares obtained in the resharing step by resharing the exponent that has been decomposed into additions of shares of the exponent.

According to a fourth aspect of the present invention, there is provided a secure computation program causing at least four secure computation server apparatuses connected to each other via a network to execute secure exponentiation involving a non-secret base and a secret exponent, the secure computation program including: a resharing step of outputting reshares for an input including at least a share of the exponent by an operation closed within each of the secure computation server apparatuses; and a multiplication step of performing the secure exponentiation by executing multiplication using shares obtained in the resharing step by resharing the exponent that has been decomposed into additions of shares of the exponent. Further, this program can be stored in a computer-readable storage medium. The storage medium may be a non-transient one such as a semiconductor memory, a hard disk, a magnetic recording medium, an optical recording medium, and the like. The present invention can also be realized as a computer program product.

### Advantageous Effects of Invention

According to each aspect of the present invention, it becomes possible to provide a secure computation system, secure computation server apparatus, secure computation method, and secure computation program that contribute to definitive fraud detection in secure exponentiation.

### BRIEF DESCRIPTION OF DRAWINGS

FIG. 1 is a block diagram showing an example of the functional configuration of a secure computation system according to a first example embodiment.

FIG. 2 is a block diagram showing an example of the functional configuration of a secure computation server apparatus according to the first example embodiment.

FIG. 3 is a block diagram showing an example of the functional configuration of a secure computation system according to a second example embodiment.

FIG. 4 is a block diagram showing an example of the functional configuration of a secure computation server apparatus according to the second example embodiment.

FIG. 5 is a flowchart showing an outline of the procedure of a secure computation method.

FIG. 6 is a drawing illustrating an example of the hardware configuration of the secure computation server apparatus.

### EXAMPLE EMBODIMENTS

Example embodiments of the present invention will be described with reference to the drawings. The present invention, however, is not limited to the example embodiments described below. Further, in each drawing, the same or corresponding elements are appropriately designated by the same reference signs. It should also be noted that the drawings are schematic, and the dimensional relationships and the ratios between the elements may differ from the actual ones. The dimensional relationships and the ratios between drawings may also be different in some sections.

### First Example Embodiment

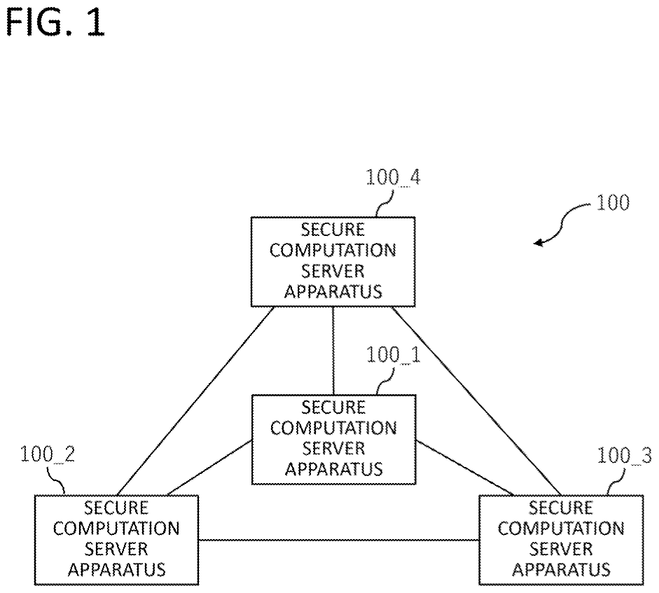

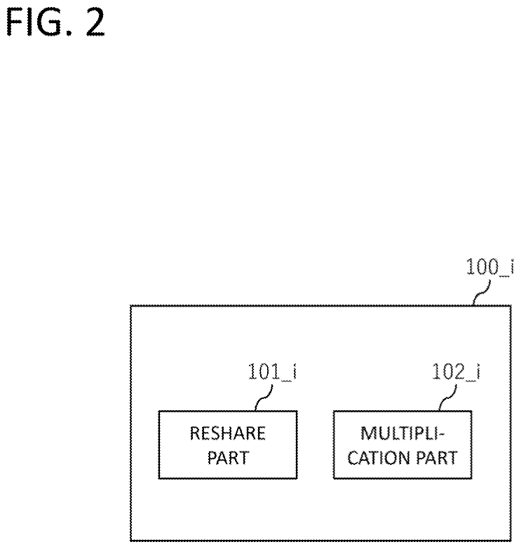

The following describes a secure computation system and a secure computation server apparatus relating to a first example embodiment with reference to FIGS. 1 and 2.

FIG. 1 is a block diagram showing an example of the functional configuration of the secure computation system according to the first example embodiment. As shown in FIG. 1, the secure computation system 100 according to the first example embodiment comprises a first secure computation server apparatus 100_1, a second secure computation server apparatus 1002, a third secure computation server apparatus 100_3, and a fourth secure computation server apparatus 100_4. The first, the second, the third, and the fourth secure computation server apparatuses 100_1, 100_2, 100_3, and 100_4 are connected to each other via a network so as to be able to communicate with each other.

The secure computation system 100 comprising the first to the fourth secure computation server apparatuses 100_i (i=1, 2, 3, 4) is able to compute desired shares of a value supplied by one of the first to the fourth secure computation server apparatuses 100_i (i=1, 2, 3, 4) as an input while keeping the input value and the values during the computation process secret, and distribute the computation results to the first to the third secure computation server apparatuses 100_i (i=1, 2, 3) to store them therein.

Further, the secure computation system 100 comprising the first to the fourth secure computation server apparatuses 100_i (i=1, 2, 3, 4) is able to compute desired shares of shares distributed to and stored in the first to the fourth secure computation server apparatuses 100_i (i=1, 2, 3, 4) while keeping the values during the computation process secret, and distribute the computation results to the first to the third secure computation server apparatuses 100_i (i=1, 2, 3) to store them therein.

Further, the shares that resulted from the computations above may be reconstructed by exchanging the shares with the first to the fourth secure computation server apparatuses 100_1 to 100_4. Alternatively, the shares may be decoded by transmitting them to an external apparatus, instead of the first to the fourth secure computation server apparatuses 100_1 to 100_4.

Further, the secure computation system 100 comprising the first to the fourth secure computation server apparatuses 100_i (i=1, 2, 3, 4) is able to verify whether or not there is any fraudulence (for instance, falsification) in the information exchanged among the first to the fourth secure computation server apparatuses 100_i (i=1, 2, 3, 4). For instance, the first to the third secure computation server apparatuses 100_i (i=1, 2, 3) are able to verify whether or not there is any fraudulence in information transmitted by the fourth secure computation server apparatus 100_4 to the first to the third secure computation server apparatuses 100_i (i=1, 2, 3) while maintaining confidentiality.

The first to the third secure computation server apparatuses 100_i (i=1, 2, 3) can verify whether or not there is any fraudulence (for instance, falsification) in the information received from the fourth secure computation server apparatus 100_4 by comparing among the first to the third secure computation server apparatuses 100_i (i=1, 2, 3) the computation results obtained by combining the information received from the fourth secure computation server apparatus 100_4 with the share held by each of the first to the third secure computation server apparatuses 100_i (i=1, 2, 3).

For instance, in order to be able to verify whether or not there is any fraudulence (for instance, falsification) in the information exchanged among the first to the fourth secure computation server apparatuses 100_i (i=1, 2, 3, 4) as described above, shares can be configured as follows.

Shares of xϵZq for each participant Pi (i=0, 1, 2, 3) are defined as follows.

[x]^{q}=([x]₀^{q},[x]₁^{q},[x]₂^{q},[x]₃^{q})

μₓ=x+σₓ mod q

σₓ=σₓ¹+σₓ² mod q

μₓ=μₓ¹+μₓ² mod q

[x]₀^{q}=(σₓ¹,μₓ¹,μₓ²)

[x]₁^{q}=(σₓ¹,σₓ²,μₓ¹)

[x]₂^{q}=(σₓ²,μₓ¹,μₓ²)

[x]₃^{q}=(σₓ¹,σₓ²,μₓ²)

x=−σₓ¹−σₓ²+μₓ¹+μₓ² mod q [Math. 1]

By configuring the shares as above and using the method described in Non-Patent Literature 1, along with normal addition and multiplication, whether or not there is any fraudulence (for instance, falsification) in the information exchanged among the first to the fourth secure computation server apparatuses 100_i (i=1, 2, 3, 4) can be verified.

Next, let us consider exponentiation. The exponentiation discussed herein is secure exponentiation involving a non-secret base and a secret exponent; it is an operation that obtains [b^{x}]^{q} from b that is not secret-shared and [x]^{q} that is secret-shared.

[b^{x}]^{q}←exp(b,[x]^{q}),bϵ [symbol] _{q} [Math. 2]

Here, considering that x=−σₓ¹−σₓ²+μₓ¹+σₓ² mod q, we can decompose b^{x} as follows.

b^{x}=b^{-σ}^{ₓ}^{¹}^{-σ}^{ₓ}^{²}^{+μ}^{ₓ}^{¹}^{+μ}^{ₓ}^{²}=b^{-σ}^{ₓ}^{¹}b^{-σ}^{ₓ}^{²}b^{μ}^{ₓ}^{¹}b^{μ}^{ₓ}^{²} mod q [Math. 3]

In other words, if each of b\hat{ }{−σₓ¹}, b\hat{ }{−σₓ²}, b\hat{ }{μₓ¹}, b\hat{ }{μₓ²} is obtained, b^{x} can also be calculated. Note that, since {−σₓ¹, −σₓ², μₓ¹, μₓ²} are values constituting shares distributed to and held in the first to the fourth secure computation server apparatuses 100_i (i=1, 2, 3, 4), any one of the first to the fourth secure computation server apparatuses 100_i (i=1, 2, 3, 4) cannot obtain all of these values at one time. Moreover, what needs to be derived is the share [b^{x}]^{q} for obtaining b^{x} though secure computation.

Therefore, in the present example embodiment, each of the first to the fourth secure computation server apparatuses 100_i (i=1, 2, 3, 4) comprises a reshare part 101_i (i=1, 2, 3, 4) that outputs reshares for an input including at least a share of the exponent x by an operation closed within each apparatus and a multiplication part 102_i (i=1, 2, 3, 4) that performs secure exponentiation by executing multiplication using the reshares obtained by the reshare part 101_i (i=1, 2, 3, 4), as shown in FIG. 2.

Then, the reshare part 101_i (i=1, 2, 3, 4) receives the base b that is not secret-shared and the exponent [x]^{q} that is secret-shared as an input and outputs reshares of [b^{x}]^{q}, the result of the exponentiation of the exponent [x]^{q} with respect to the base b, as follows.

([b^{-σ}^{ₓ}^{¹}]^{q},[b^{-σ}^{ₓ}^{²}]^{q},[b^{μ}^{ₓ}^{¹}]^{q},[b^{μ}^{ₓ}^{²}]^{q})←Reshare_Exp(b,[x]^{q})

[b^{-σ}^{ₓ}^{¹}]₀^{q}=(b^{-σ}^{ₓ}^{¹},0,0),[b^{-σ}^{ₓ}^{¹}]₁^{q}=(b^{-σ}^{ₓ}^{¹},0,0),[b^{-σ}^{ₓ}^{¹}]₂^{q}=(0,0,0),[b^{-σ}^{ₓ}^{¹}]₃^{q}=(b^{-σ}^{ₓ}^{¹},0,0)

[b^{-σ}^{ₓ}^{²}]^{q},[b^{μ}^{ₓ}^{¹}]^{q},[b^{μ}^{ₓ}^{²}]^{q} [Math. 4]

are also defined in the same manner.

As can be seen from the above definitions, the shares other than the one held within the apparatus are treated as zero in this reshare operation. In other words, a secure computation server apparatus does not need to communicate with the other secure computation server apparatuses in order to obtain the shares that it does not have. This reshare operation is closed within each secure computation server apparatus, and such a reshare process is sometimes called “local reshare”.

Meanwhile, the multiplication part 102_i (i=1, 2, 3, 4) obtains [b^{x}]^{q}, the result of the exponentiation of the exponent [x]^{q} with respect to the base b, using the reshares obtained by the reshare part 101_i (i=1, 2, 3, 4) as follows.

[b^{x}]^{q}=[b^{-σ}^{ₓ}^{¹}^{-σ}^{ₓ}^{²}^{+μ}^{ₓ}^{¹}^{+μ}^{ₓ}^{²}]^{q}=[b^{-σ}^{ₓ}^{¹}]^{q}·[b⁻^{ₓ}^{²}]^{q}·[b^{μ}^{ₓ}^{¹}]^{q}·[b^{μ}^{ₓ}^{²}]^{q} [Math. 5]

As described, in the present example embodiment, the exponentiation that obtains [b^{x}]^{q} from b that is not secret-shared and [x]^{q} that is secret-shared as an input can be performed by providing in each of the first to the fourth secure computation server apparatuses 100_i (i=1, 2, 3, 4): the reshare part 101_i (i=1, 2, 3, 4) that outputs reshares for an input including at least a share of the exponent x by an operation closed within each of the first to the fourth secure computation server apparatuses 100_i (i=1, 2, 3, 4); and the multiplication part 102_i (i=1, 2, 3, 4) that performs secure exponentiation by executing multiplication using shares obtained by having the reshare part 101_i (i=1, 2, 3, 4) reshare the exponent x that has been decomposed into additions of shares of the exponent.

Further, it becomes possible to contribute to definitive fraud detection in secure exponentiation since the secure computation system 100 comprises the first to the fourth secure computation server apparatuses 100_i (i=1, 2, 3, 4) and is able to verify whether or not there is any fraudulence (for instance, falsification) in the information exchanged among the first to the fourth secure computation server apparatuses 100_i (i=1, 2, 3, 4).

### Second Example Embodiment

Next, the following describes an example embodiment in which the secure exponentiation described in the first example embodiment is more concretely implemented. In the first example embodiment, exponentiation is simply decomposed into products, however, sometimes this alone may not be sufficient. For instance, if the modulus q is a prime p and Fermat's little theorem is used, b^{x}=b^{x′+kq}=b^{x′+k} mod q. Then, if the exponent x exceeds the modulus q, the exponentiation result b^{x} must be multiplied by b¹. In the second example embodiment, the case where the modulus q is a prime p (q=p) will be described.

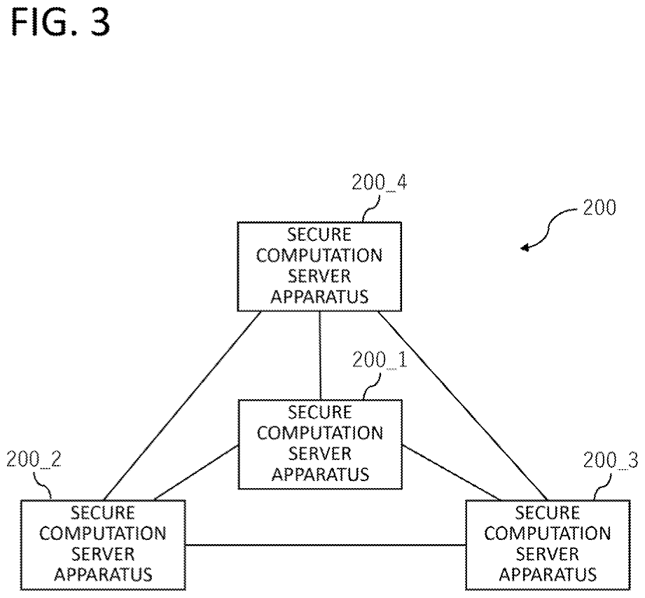

FIG. 3 is a block diagram showing an example of the functional configuration of a secure computation system according to the second example embodiment. As shown in FIG. 3, the secure computation system 200 according to the second example embodiment comprises a first secure computation server apparatus 200_1, a second secure computation server apparatus 200_2, a third secure computation server apparatus 200_3, and a fourth secure computation server apparatus 200_4. The first, the second, the third, and the fourth secure computation server apparatuses 200_1, 200_2, 200_3, and 200_4 are connected to each other via a network so as to be able to communicate with each other.

In addition to being able to perform secure computation in the same manner as in the first example embodiment, the secure computation system 200 comprising the first to the fourth secure computation server apparatuses 200_i (i=1, 2, 3, 4) is also able to verify whether or not there is any fraudulence (for instance, falsification) in information exchanged among the first to the fourth secure computation server apparatuses 200_i (i=1, 2, 3, 4).

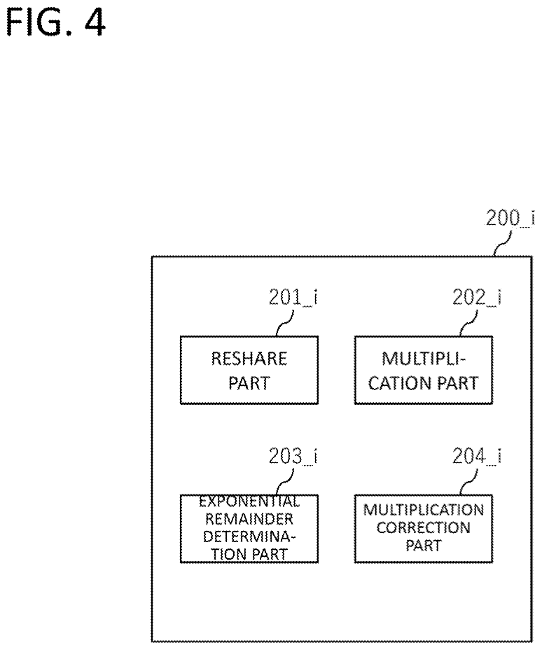

Further, as shown in FIG. 4, each of the first to the fourth secure computation server apparatuses 200_i (i=1, 2, 3, 4) comprises a reshare part 201_i (i=1, 2, 3, 4) that outputs reshares for an input including at least a share of the exponent x by an operation closed within each apparatus and a multiplication part 202_i (i=1, 2, 3, 4) that performs secure exponentiation by executing multiplication using the reshares obtained by the reshare part 201_i (i=1, 2, 3, 4).

In addition, each of the first to the fourth secure computation server apparatuses 200_i (i=1, 2, 3, 4) comprises an exponential remainder determination part 203_i (i=1, 2, 3, 4) that determines whether or not the exponent x exceeds the modulus p and a multiplication correction part 204_i (i=1, 2, 3, 4) that performs multiplication that corrects a value on the basis of a result from the exponential remainder determination part 203_i (i=1, 2, 3, 4).

Shares are configured in the same manner as in the first example embodiment. In other words, shares of xϵZq for each participant Pi (i=0, 1, 2, 3) are defined as follows.

[x]^{q}=([x]₀^{q},[x]₁^{q},[x]₂^{q},[x]₃^{q})

μₓ=x+σₓ mod q,σₓ=σₓ¹+σₓ² mod q,μₓ=μₓ¹+μₓ² mod q

[x]₀^{q}=(σₓ¹,μₓ¹,μₓ²)

[x]₁^{q}=(σₓ¹,μₓ²,μₓ¹)

[x]₂^{q}=(σₓ²,μₓ¹,μₓ²)

[x]₃^{q}=(σₓ¹,μₓ²,μₓ²)

x=−σₓ¹−σₓ²+μₓ¹+μₓ² mod q [Math. 6]

Here, as described above, if p is a prime and Fermat's little theorem is used, b^{x}=b^{x′+kq}=b^{x′+k} mod q. Meanwhile, given that x=−σₓ¹−σₓ²+μₓ¹+μₓ², kϵ{0, 1, 2, 3}. In other words, the exponent x can exceed the modulus p by at most three times.

The exponential remainder determination part 203_i (i=1, 2, 3, 4) determines whether or not the exponent exceeds the modulus in additions of exponent shares obtained by decomposing the exponent. Specifically, the exponential remainder determination part determines whether or not the exponent exceeds the modulus in three additions: −σₓ¹−σₓ², (−σₓ¹−σₓ²)+μₓ¹, and ((−σₓ¹−σₓ²)+μₓ¹)+σₓ².

One can determine whether or not the exponent exceeds the modulus by noting that the modulus p is a prime and that the parity is reversed when the exponent exceeds the modulus p. For instance, if a0 is even and a1 is odd, a0+a1 is even when (1) a0+a1 exceeds the modulus. Meanwhile, if (1) a0+a1 does not exceed the modulus, a0+a1 is odd. Further, one can determine whether the parity is reversed by looking for an inversion of the least significant bit.

### (Secure Computation Method)

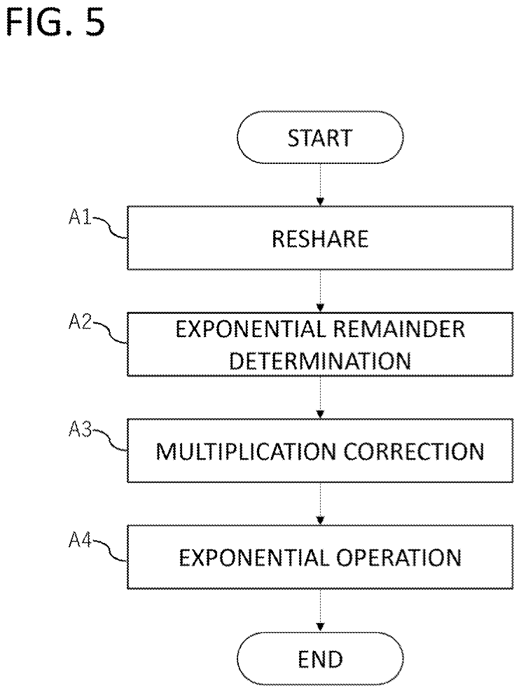

The following describes a secure computation method in detail. FIG. 5 is a flowchart showing an outline of the procedure of the secure computation method.

In step A1, resharing is performed. In other words, reshares of b^{x}, the result of the exponentiation of the exponent x with respect to the base b, are calculated for an input including the base b and a share of the exponent x, and reshares of the least significant bit of the exponent x are calculated for an input including a share of the exponent x. Specifically, the following calculations are performed.

([b^{-σ}^{ₓ}^{¹}]^{q},[b^{-σ}^{ₓ}^{²}],[b^{μ}^{ₓ}^{¹}]^{q},[b^{μ}^{ₓ}^{²}]^{q})←Reshare_Exp(b,[x]^{q})

[b^{-σ}^{ₓ}^{¹}]₀^{q}=(b^{-σ}^{ₓ}^{¹},0,0),[b^{-σ}^{ₓ}^{¹}]₁^{q}=(b^{-σ}^{ₓ}^{¹},0,0,),[b^{-σ}^{ₓ}^{¹}]₂^{q}=(0,0,0),[b^{-σ}^{ₓ}^{¹}]₃^{q}=(b^{-σ}^{ₓ}^{¹},0,0)

[b^{-σ}^{ₓ}^{²}]^{q},[b^{μ}^{ₓ}^{¹}]^{q},[b^{μ}^{ₓ}^{²}]^{q} [Math. 7]

are also defined in the same manner.

([−σₓ¹]^{q},[−σₓ²]^{q},[μₓ¹]^{q},[μₓ²]^{q})←Reshare([x]^{q})

[−σₓ¹]^{q},[−σₓ²]^{q},[μₓ¹]^{q},[μₓ²]^{q}

are also defined in the same manner as above.

{([−σₓ¹|ⱼ]^{q},[−σₓ²|ⱼ]^{q},[μₓ¹|ⱼ]^{q},[μₓ²|ⱼ]^{q})}ⱼ₌₀^{log(q)}←Reshare_Bit([x]4)

[−σₓ¹|ⱼ]^{q},[−σₓ²|ⱼ]^{q},[μₓ¹|ⱼ]^{q},[μₓ²|ⱼ]^{q}

are also defined in the same manner as above.

In step A2, the exponential remainder is determined. In other words, whether or not the exponent x exceeds the modulus is determined. For this, the following calculations are performed.

Using the results of the resharing in the step A1, the following calculations are executed. Note that the values below appear to give the shares of the exponentiation result, but do not give the proper value when the exponent x exceeds the modulus, as mentioned above.

[res₀]^{p}=[b^{-σ}^{ₓ}^{¹}]^{p}·[b^{-σ}^{ₓ}^{²}]^{p}·[b^{μ}^{ₓ}^{¹}]^{p}·[b^{μ}^{ₓ}^{²}]^{p} [Math. 8]

Then, as described above, whether or not the exponent x exceeds the modulus p is determined by finding out if the exponent exceeds the modulus in three additions: −σₓ¹−σₓ², (−σₓ¹−σₓ²)+μₓ¹, and ((−σₓ¹−σₓ²)+μₓ¹)+μₓ².
(1) Determine whether−σₓ¹−σₓ² exceeds the modulus. Note that LSB in the calculations below denotes the least significant bit. Further, [k₀]^{p} is a variable designed to be one when −σₓ¹−σₓ² exceeds the modulus p and zero otherwise. Logical operations appear in the middle thereof to determine if the parity is reversed, but the calculation boils down to the computation of the least significant bit.

[l₀]^{p}=LSB([−σₓ¹]^{p}+[−σₓ²]^{p})

[k₀]^{p}=[−σₓ¹−σₓ²>p]=[((−σₓ¹)|₀⊕(−σₓ²)|₀)≠l₀]^{p}

=[(−σₓ¹)|₀⊕(−σₓ²)|₀⊕l₀]^{p}=(([−σₓ¹|₀]^{p}−[−σₓ²|₀]^{p})²−[−l₀]^{p})² [Math. 9]
(2) Determine if (−σₓ¹−σₓ²)+μₓ¹ exceeds the modulus. In the calculations below, [k₁]^{p} is a variable designed to be one when (−σₓ¹−σₓ²)+μₓ¹ exceeds the modulus p and zero otherwise.

[l₁]^{p}=LSB([−σₓ¹]^{p}+[−σₓ²]^{p}+[μₓ¹]^{p})

[k₁]^{p}=[l₀⊕μₓ¹|₀⊕l₁]^{p}=(([l₀]^{p}−[μₓ¹|₀]^{p})²−[l₁]^{p})² [Math. 10]
(3) Determine whether or not ((−σₓ¹−σₓ²)+μₓ¹)+μₓ² exceeds the modulus. In the calculations below, [k₂]^{p} is a variable designed to be one when ((−σₓ¹−σₓ²)+μₓ¹)+μₓ² exceeds the modulus p and zero otherwise.

[l₂]^{p}=LSB([−σₓ¹]^{p}+[−σₓ²]^{p}+[μₓ¹]^{p}+[μₓ²]^{p})

[k₂]^{p}=[l₁⊕μₓ²|₀l₂]^{p}=(([l₁]^{p}−[μₓ²|₀]^{p})²−[l₂]^{p})² [Math. 11]

In step A3, multiplication correction is performed. In other words, the value is corrected on the basis of the results from the exponential remainder determination in the step A2. Using [k₀]^{p}, [k₁]^{p}, and [k₂]^{p} calculated as above, [res₀]^{p} is corrected as follows.

[res₁]^{p}=(1−[k₀]^{p})·[res₀]^{p}+[k₀]^{p}·b⁻¹·[res₀]^{p}

[res₂]^{p}=(1−[k₁]^{p})·[res₁]^{p}+[k₁]^{p}·b⁻¹[res₁]^{p}

[res₃]^{p}=(1−[k₂]^{p})·[res₂]^{p}+[k₂]^{p}·b⁻¹·[res₂]^{p} [Math. 12]

Since [k₀]^{p}, [k₁]^{p}, and [k₂]^{p} are one when the exponent exceeds the modulus and are zero otherwise, the right sides of the above formulas are multiplied by b⁻¹ when the exponent exceeds the modulus.

In step A4, the corrected [res₃]^{p} is outputted as the result [b^{x}]^{q} of the exponentiation of the exponent x with respect to the base b.

As described, in the present example embodiment, even in the case where the modulus p is a prime, whether or not the exponent x exceeds the modulus p is determined, and the exponentiation that obtains [b^{x}]^{q} can be performed from the base b that is not secret-shared and the exponent [x]^{p} that is secret-shared as an input.

Further, it becomes possible to contribute to definitive fraud detection in secure exponentiation since the secure computation system 200 comprises the first to the fourth secure computation server apparatuses 200_i (i=1, 2, 3, 4) and is able to verify whether or not there is any fraudulence (for instance, falsification) in the information exchanged among the first to the fourth secure computation server apparatuses 200_i (i=1, 2, 3, 4).

### Third Example Embodiment

Next, the following describes an example embodiment in which the secure exponentiation described in the second example embodiment is modified. The exponent could exceed the modulus three times in the second example embodiment, however, if the base and the exponent have different moduli, the number of conditional determinations can be reduced in some cases.

For instance, let us consider a case where a base modulo p′ and an exponent modulo q′ are primes satisfying p′=3q′+1 and [b^{x}]^{p′}←exp(b, [x]^{q′}) is executed. Here, if −σₓ¹, −σₓ², μₓ¹, μₓ²ϵ[0, q′−1] and bϵ[0, p′−1], the number of times x=−σₓ¹−σₓ²+μₓ¹+μₓ² exceeds the modulus can be reduced to one.

Here, further description is omitted because the configuration and the calculation procedures described in the second example embodiment can also be used in the present example embodiment, and the exponentiation that obtains [b^{x}]^{p} can also be performed from the base b that is not secret-shared and the exponent [x]^{p} that is secret-shared as an input in the present example embodiment. Further, it becomes possible to contribute to definitive fraud detection in secure exponentiation since whether or not there is any fraudulence (for instance, falsification) in the exchanged information can also be verified in the present example embodiment.

### Fourth Example Embodiment

Next, the following describes an example embodiment in which the modulus is a power of two. When the modulus is a power of two, i.e., when q=2^{m}, bϵZ₂^{m} and the exponentiation that obtains [b^{x}]^{q} from b that is not secret-shared and [x]^{q} that is secret-shared as an input can be performed as follows. Note, however, that only cases where the base b is odd are considered here.

[b^{x}]²^{^{m}}←exp(b,[x]²^{^{m}}),bϵZ₂_{^{m}} [Math. 13]

In this case, as in the first example embodiment, from the base b that is not secret-shared and the exponent [x]^{q} that is secret-shared as an input, reshares of [b^{x}]^{q}, the result of the exponentiation of the exponent [x]^{q} with respect to the base b, can be defined.

([b^{-σ}^{ₓ}^{¹}]²^{^{m}},[b^{-σ}^{ₓ}^{²}]²^{^{m}},[b^{μ}^{ₓ}^{¹}]²^{^{m}},[b^{μ}^{ₓ}^{²}]²^{^{m}})←Reshare_Exp(b,[x]²^{^{m}})

[b^{-σ}^{ₓ}^{¹}]₀²^{^{m}}=(b^{-σ}^{ₓ}^{¹},0,0),[b^{-σ}^{ₓ}^{¹}]₁²^{^{m}}=(b^{-σ}^{ₓ}^{¹},0,0),[b^{-σ}^{ₓ}^{¹}]₂²^{^{m}}=(0,0,0),[b^{-σ}^{ₓ}^{¹}]₃²^{^{m}}=(b^{-σ}^{ₓ}^{¹},0,0)

[b^{-σ}^{ₓ}^{²}]²^{^{m}},[b^{μ}^{ₓ}^{¹}]²^{^{m}},[b^{μ}^{ₓ}^{²}]²^{^{m}} [Math. 14]

are also defined in the same manner.

Here, whether or not a correction also needs to be made when the exponent x exceeds the modulus, as is the case with a prime modulus, will be examined in the case of the present example embodiment (when the modulus is a power of two).

If base b is odd, the base b and the modulus 2^{m} are mutually prime. Then, the following relational expression holds from Euler's theorem.

b²^{^{m-1}}=1 mod 2^{m}

b²^{^{m}}=(b²^{^{m-1}})·(b²^{^{m-1}})=1 mod 2^{m} [Math. 15]

In other words, no correction is required even when the exponent exceeds 2^{m}. Therefore, the exponentiation of the exponent [x]^{q} with respect to the base b can be performed by executing the following calculation using the reshares above.

[b^{x}]²^{^{m}}=[b^{-σ}^{ₓ}^{¹}^{-σ}^{ₓ}^{²}^{+μ}^{ₓ}^{¹}^{+μ}^{ₓ}^{²}]²^{^{m}}=([b^{-σ}^{ₓ}^{¹}]²^{^{m}}·[b^{-σ}^{ₓ}^{²}]²^{^{m}})·([b^{μ}^{ₓ}^{¹}]²^{^{m}}·[b^{μ}^{ₓ}^{²}]²^{^{m}}) [Math. 16]

Further description is omitted because the configuration and the calculation procedures described in the first example embodiment can also be used in the present example embodiment, and the exponentiation that obtains [b^{x}]^{p} can also be performed from the base b that is not secret-shared and the exponent [x]^{p} that is secret-shared as an input in the present example embodiment. Further, it becomes possible to contribute to definitive fraud detection in secure exponentiation since whether or not there is any fraudulence (for instance, falsification) in the exchanged information can also be verified in the present example embodiment.

### [Hardware Configuration]

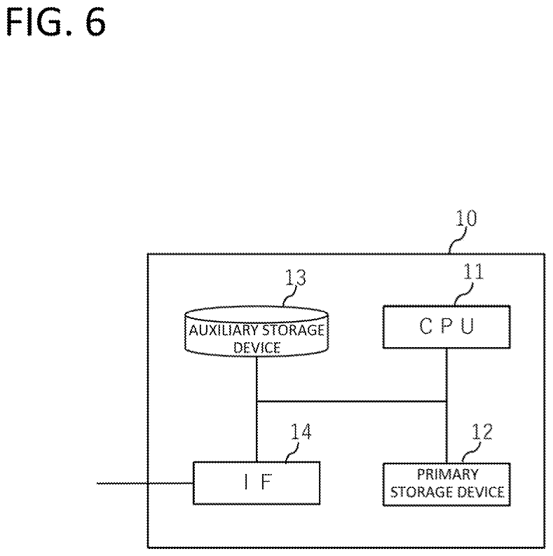

FIG. 6 is a drawing illustrating an example of the hardware configuration of the secure computation server apparatus. In other words, FIG. 6 shows an example of the hardware configuration of the secure computation server apparatuses 100_i and 200_i (i=1, 2, 3, 4). An information processing apparatus (computer) employing the hardware configuration shown in FIG. 6 can achieve the functions of the secure computation server apparatuses 100_i and 200_i (i=1, 2, 3, 4) by executing the secure computation method described above as a program.

It should be noted that the hardware configuration example shown in FIG. 6 is merely an example of the hardware configuration that achieves the functions of the secure computation server apparatuses 100_i and 200_i (i=1, 2, 3, 4), and is not intended to limit the hardware configuration of the secure computation server apparatuses 100_i and 200_i (i=1, 2, 3, 4). The secure computation server apparatuses 100_i and 200_i (i=1, 2, 3, 4) may include hardware not shown in FIG. 6.

As shown in FIG. 6, the hardware configuration 10 that may be employed by the secure computation server apparatuses 100_i and 200_i (i=1, 2, 3, 4) comprises a CPU (Central Processing Unit) 11, a primary storage device 12, an auxiliary storage device 13, and an IF (interface) part 14. These elements are connected to each other by, for instance, an internal bus.

The CPU 11 executes each instruction included in a secure computation program executed by the secure computation server apparatuses 100_i and 200_i (i=1, 2, 3, 4). The primary storage device 12 is, for instance, a RAM (Random Access Memory) and temporarily stores various programs such as the secure computation program executed by the secure computation server apparatuses 100_i and 200_i (i=1, 2, 3, 4) so that the CPU 11 can process the programs.

The auxiliary storage device 13 is, for instance, an HDD (Hard Disk Drive) and is capable of storing the various programs, such as the secure computation program executed by the secure computation server apparatuses 100_i and 200_i (i=1, 2, 3, 4), in the medium to long term. The various programs such as the secure computation program may be provided as a program product stored in a non-transitory computer-readable storage medium. The auxiliary storage device 13 can be used to store the various programs such as the secure computation program stored in the non-transitory computer-readable storage medium over the medium to long term. The IF part 14 provides an interface to the input and output between the secure computation server apparatuses 100_i and 200_i (i=1, 2, 3, 4).

The information processing apparatus employing the hardware configuration 10 described above can achieve the functions of the secure computation server apparatuses 100_i and 200_i (i=1, 2, 3, 4) by executing the secure computation method described above as a program.

Some or all of the example embodiments above can be described as (but not limited to) the following Supplementary Notes.

### [Supplementary Note 1]

A secure computation system for secure exponentiation involving a non-secret base and a secret exponent comprising at least four secure computation server apparatuses connected to each other via a network, wherein
each of the secure computation server apparatuses has:
a reshare part that outputs reshares for an input including at least a share of the exponent by an operation closed within each of the secure computation server apparatuses; and
a multiplication part that performs the secure exponentiation by executing multiplication using shares obtained by having the reshare part reshare the exponent that has been decomposed into additions of shares of the exponent.

### [Supplementary Note 2]

The secure computation system according to Supplementary Note 1, wherein
each of the secure computation server apparatuses further comprises: an exponential remainder determination part that determines whether or not the exponent exceeds a modulus; and
a multiplication correction part that performs multiplication that corrects a value on the basis of a result from the exponential remainder determination part.

### [Supplementary Note 3]

The secure computation system according to Supplementary Note 2, wherein the exponential remainder determination part determines whether or not the exponent exceeds a modulus by determining if the least significant bit of the exponent is inverted in each addition of shares of the exponent obtained by decomposing the exponent.

### [Supplementary Note 4]

The secure computation system according to Supplementary Note 3, wherein the reshare part outputs reshares of the exponentiation of the exponent with respect to the base for an input including the base and a share of the exponent and outputs reshares of the least significant bit of the exponent for an input including a share of the exponent.

### [Supplementary Note 5]

A secure computation server apparatus out of at least four secure computation server apparatuses connected to each other via a network, the secure computation server apparatus including:
a reshare part that outputs reshares for an input including at least a share of an exponent by an operation closed within each of the secure computation server apparatuses; and
a multiplication part that performs secure exponentiation by executing multiplication using shares obtained by having the reshare part reshare the exponent that has been decomposed into additions of shares of the exponent.

### [Supplementary Note 6]

A secure computation method performing secure exponentiation involving a non-secret base and a secret exponent using at least four secure computation server apparatuses connected to each other via a network, the secure computation method including:
a resharing step of outputting reshares for an input including at least a share of the exponent by an operation closed within each of the secure computation server apparatuses; and
a multiplication step of performing the secure exponentiation by executing multiplication using shares obtained in the resharing step by resharing the exponent that has been decomposed into additions of shares of the exponent.

### [Supplementary Note 7]

The secure computation method according to Supplementary Note 6 further including:
an exponential remainder determination step of determining whether or not the exponent exceeds a modulus; and
a multiplication correction step of performing multiplication that corrects a value on the basis of a result from the exponential remainder determination part.

### [Supplementary Note 8]

The secure computation method according to Supplementary Note 7, wherein the exponential remainder determination step determines whether or not the exponent exceeds a modulus by determining if the least significant bit of the exponent is inverted in each addition of shares of the exponent obtained by decomposing the exponent.

### [Supplementary Note 9]

The secure computation method according to Supplementary Note 8, wherein the resharing step outputs reshares of the exponentiation of the exponent with respect to the base for an input including the base and a share of the exponent and outputs reshares of the least significant bit of the exponent for an input including a share of the exponent.

### [Supplementary Note 10]

A secure computation program causing at least four secure computation server apparatuses connected to each other via a network to execute secure exponentiation involving a non-secret base and a secret exponent, the secure computation program including:
a resharing process of outputting reshares for an input including at least a share of the exponent by an operation closed within each of the secure computation server apparatuses; and
a multiplication process of performing the secure exponentiation by executing multiplication using shares obtained in the resharing process by resharing the exponent that has been decomposed into additions of shares of the exponent.

Further, the disclosure of each Patent Literature and Non-Patent Literature cited above is incorporated herein in its entirety by reference thereto. It is to be noted that it is possible to modify or adjust the example embodiments or examples within the scope of the whole disclosure of the present invention (including the Claims) and based on the basic technical concept thereof. Further, it is possible to variously combine or select (or partially omit) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims and the technical concept of the present invention. Particularly, any numerical ranges disclosed herein should be interpreted that any intermediate values or subranges falling within the disclosed ranges are also concretely disclosed even without specific recital thereof. In addition, using some or all of the disclosed matters in the literatures cited above as necessary, in combination with the matters described herein, as part of the disclosure of the present invention in accordance with the object of the present invention shall be considered to be included in the disclosed matters of the present application.

### REFERENCE SIGNS LIST

100, 200: secure computation system
100_i, 200_i: secure computation server apparatus
101_i, 201_i: reshare part
102_i, 202_i: multiplication part
203_i: exponential remainder determination part
204_i: multiplication correction part
10: hardware configuration
11: CPU (Central Processing Unit)
12: primary storage device
13: auxiliary storage device
14: IF (Interface) part

What is claimed is:

1. A secure computation system for secure exponentiation involving a non-secret base and a secret exponent, comprising at least four secure computation server apparatuses connected to each other via a network, wherein
each of the secure computation server apparatuses has:
a reshare part that outputs reshares for an input including at least a share of the exponent by an operation closed within each of the secure computation server apparatuses; and
a multiplication part that performs the secure exponentiation by executing multiplication using shares obtained by having the reshare part reshare the exponent that has been decomposed into additions of shares of the exponent.

2. The secure computation system according to claim 1, wherein
each of the secure computation server apparatuses further comprises:
an exponential remainder determination part that determines whether or not the exponent exceeds a modulus; and
a multiplication correction part that performs multiplication that corrects a value on the basis of a result from the exponential remainder determination part.

3. The secure computation system according to claim 2, wherein the exponential remainder determination part determines whether or not the exponent exceeds a modulus by determining if the least significant bit of the exponent is inverted in each addition of shares of the exponent obtained by decomposing the exponent.

4. The secure computation system according to claim 3, wherein the reshare part outputs reshares of the exponentiation of the exponent with respect to the base for an input including the base and a share of the exponent and outputs reshares of the least significant bit of the exponent for an input including a share of the exponent.

5. A secure computation server apparatus out of at least four secure computation server apparatuses connected to each other via a network that perform secure exponentiation involving a non-secret base and a secret exponent, the secure computation server apparatus including:
a reshare part that outputs reshares for an input including at least a share of as the exponent by an operation closed within each of the secure computation server apparatuses; and
a multiplication part that performs secure exponentiation by executing multiplication using shares obtained by having the reshare part reshare the exponent that has been decomposed into additions of shares of the exponent.

6. A secure computation method performing secure exponentiation involving a non-secret base and a secret exponent using at least four secure computation server apparatuses connected to each other via a network, the secure computation method including:
resharing an input including at least a share of the exponent by an operation closed within each of the secure computation server apparatuses; and
performing the secure exponentiation by executing multiplication using shares obtained by the resharing the exponent that has been decomposed into additions of shares of the exponent.

7. The secure computation method according to claim 6 further including:
an exponential remainder determination whether or not the exponent exceeds a modulus; and
a multiplication that corrects a value on the basis of a result from the exponential remainder determination.

8. The secure computation method according to claim 7, wherein the exponential remainder determination determines whether or not the exponent exceeds a modulus by determining if the least significant bit of the exponent is inverted in each addition of shares of the exponent obtained by decomposing the exponent.

9. The secure computation method according to claim 8, wherein the resharing outputs reshares of the exponentiation of the exponent with respect to the base for an input including the base and a share of the exponent and outputs reshares of the least significant bit of the exponent for an input including a share of the exponent.

10. A non-transient computer readable medium storing a secure computation program causing at least four secure computation server apparatuses connected to each other via a network to execute secure exponentiation involving a non-secret base and a secret exponent, the secure computation program including:
a resharing process of outputting reshares for an input including at least a share of the exponent by an operation closed within each of the secure computation server apparatuses; and
a multiplication process of performing the secure exponentiation by executing multiplication using shares obtained in the resharing process by resharing the exponent that has been decomposed into additions of shares of the exponent.

11. The non-transient computer readable medium storing a secure computation program according to claim 10, further including:
an exponential remainder determination process of determining whether or not the exponent exceeds a modulus; and
a multiplication correction process of performing multiplication that corrects a value on the basis of a result from the exponential remainder determination process.

12. The non-transient computer readable medium storing a secure computation program according to claim 11, wherein the exponential remainder determination process determines whether or not the exponent exceeds a modulus by determining if the least significant bit of the exponent is inverted in each addition of shares of the exponent obtained by decomposing the exponent.

13. The non-transient computer readable medium storing a secure computation program according to claim 12, wherein the resharing process outputs reshares of the exponentiation of the exponent with respect to the base for an input including the base and a share of the exponent and outputs reshares of the least significant bit of the exponent for an input including a share of the exponent.

14. The secure computation server apparatus according to claim 5, further comprises:
an exponential remainder determination part that determines whether or not the exponent exceeds a modulus; and
a multiplication correction part that performs multiplication that corrects a value on the basis of a result from the exponential remainder determination part.

15. The secure computation server apparatus according to claim 14, wherein the exponential remainder determination part determines whether or not the exponent exceeds a modulus by determining if the least significant bit of the exponent is inverted in each addition of shares of the exponent obtained by decomposing the exponent.

16. The secure computation server apparatus according to claim 15, wherein the reshare part outputs reshares of the exponentiation of the exponent with respect to the base for an input including the base and a share of the exponent and outputs reshares of the least significant bit of the exponent for an input including a share of the exponent.
